(19) United States
(12) Patent Application Publication
(10) Pub. No.: US 2025/0379393 A1
(43) Pub. Date: Dec. 11, 2025

(54) CONNECTOR WITH FLAT CIRCUIT BODY

(71) Applicant: Yazaki Corporation, Tokyo (JP)

(72) Inventor: Tomohiko Watanabe, Shizuoka (JP)

(21) Appl. No.: 19/204,470

(22) Filed: May 9, 2025

(30) Foreign Application Priority Data
Jun. 10, 2024 (JP) 2024-093731

(51) Int. Cl. H01R 13/52; H01R 12/79

(52) U.S. Cl. CPC H01R 13/5213; H01R 12/79

(57) ABSTRACT

A connector with a flat circuit body is provided. The connector includes a flat circuit body, a terminal having one end connected to the flat circuit body, a connector housing disposed above the flat circuit body in a thickness direction of the flat circuit body and provided with a first opening on a side away from the flat circuit body in the thickness direction, and a cover covering a connection portion between the flat circuit body and the terminal and the connector housing. The cover has a second opening for drawing out the flat circuit body to an outside of the cover, and a third opening for exposing the first opening of the connector housing to the outside of the cover.

### CROSS-REFERENCE TO RELATED APPLICATIONS

This application is based on and claims priority under 35 USC 119 from Japanese Patent Application No. 2024-093731 filed on Jun. 10, 2024, the contents of which are incorporated herein by reference.

### TECHNICAL FIELD

The present disclosure relates to a connector with a flat circuit body.

### BACKGROUND ART

A cover that covers a connector mounted on a substrate has been proposed (Patent Literature 1) in the related art. Providing the cover can prevent a hand from touching a terminal of the connector and improve water-resistant performance. The connector described in Patent Literature 1 is assumed to be a surface mount type connector. For this reason, when the cover is applied to a through hole type connector, there is a problem that the cover cannot cover a terminal protruding from a back face side (a side opposite to a housing) of the substrate.

### CITATION LIST

### Patent Literature

Patent Literature 1: JP2019-67685A

### SUMMARY OF INVENTION

The present disclosure is made in view of the above-described circumstance, and an object of the present disclosure is to provide a connector with a flat circuit body that can cover a terminal regardless of whether the connector is a surface mount type connector or a through hole type connector, and achieve hand touch prevention and improvement in water-resistant performance.

To achieve the above-described object, the connector with a flat circuit body according to the present disclosure has following features.

The conner includes a flat circuit body, a terminal having one end connected to the flat circuit body, a connector housing disposed above the flat circuit body in a thickness direction of the flat circuit body and provided with a first opening on a side away from the flat circuit body in the thickness direction, the connector housing accommodating another end of the terminal, and a cover covering a connection portion between the flat circuit body and the terminal and the connector housing. The cover has a second opening for drawing out the flat circuit body to an outside of the cover, and a third opening for exposing the first opening of the connector housing to the outside of the cover.

According to the connector with a flat circuit body of the present disclosure, it is possible to cover a terminal regardless of whether the connector is a surface mount type connector or a through hole type connector, and to achieve hand touch prevention and improvement in water-resistant performance.

The present disclosure is briefly described above. Further, details of the present disclosure can be clarified by reading modes (hereinafter, referred to as “embodiments”) for carrying out the invention described below with reference to the accompanying drawings.

### BRIEF DESCRIPTION OF DRAWINGS

FIG. 1 is a perspective view of a FPC connector that is a connector with a flat circuit body of the present disclosure according to a first embodiment;

FIG. 2 is an exploded perspective view of the FPC connector illustrated in FIG. 1;

FIG. 3 is a cross-sectional view taken along a line A-A in FIG. 1;

FIG. 4 is a cross-sectional view taken along the line A-A in FIG. 1 according to a second embodiment;

FIG. 5 is a perspective view of a FPC connector that is the connector with a flat circuit body of the present disclosure according to a third embodiment;

FIG. 6 is an exploded perspective view of the FPC connector illustrated in FIG. 5;

FIG. 7 is a cross-sectional view taken along a line B-B in FIG. 5; and

FIG. 8 is a cross-sectional view taken along the line B-B in FIG. 5 according to a fourth embodiment.

### DESCRIPTION OF EMBODIMENTS

Specific embodiments of the present disclosure will be described below with reference to the drawings.

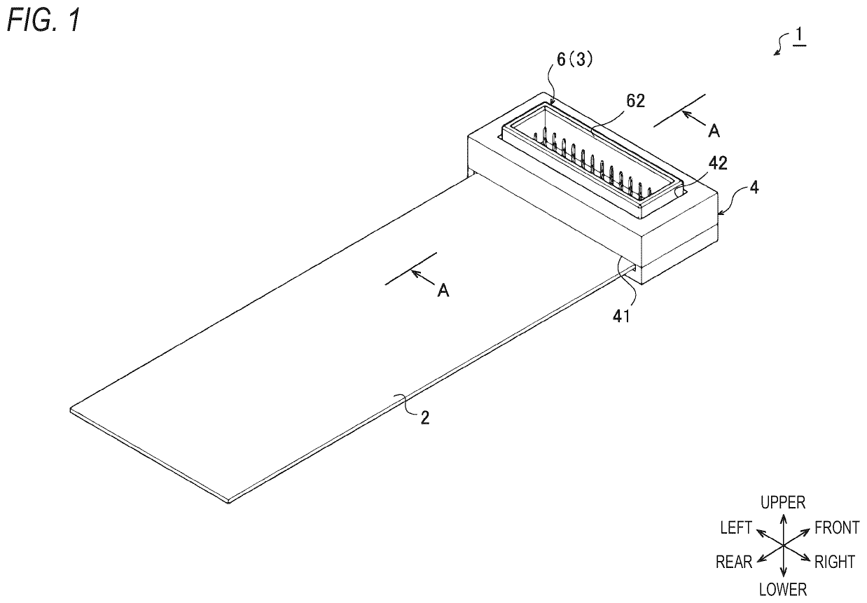

Hereinafter, for convenience of description, “front”, “rear”, “left”, “right”, “upper”, and “lower” are defined as illustrated in FIGS. 1 to 8. A “front-rear direction”, a “left-right direction”, and an “upper-lower direction” are orthogonal to one another. The “upper-lower direction” corresponds to a “thickness direction” of the present disclosure, and the “left-right direction” corresponds to a “width direction” of the present disclosure.

### First Embodiment

A FPC connector that is a connector with a flat circuit body according to a first embodiment will be described. As illustrated in FIG. 1, the FPC connector 1 includes a band-shaped flexible printed circuit (FPC) 2, a surface mount type connector 3 connected to the FPC 2, and a cover 4. The FPC 2 is a kind of flexible printed circuit board.

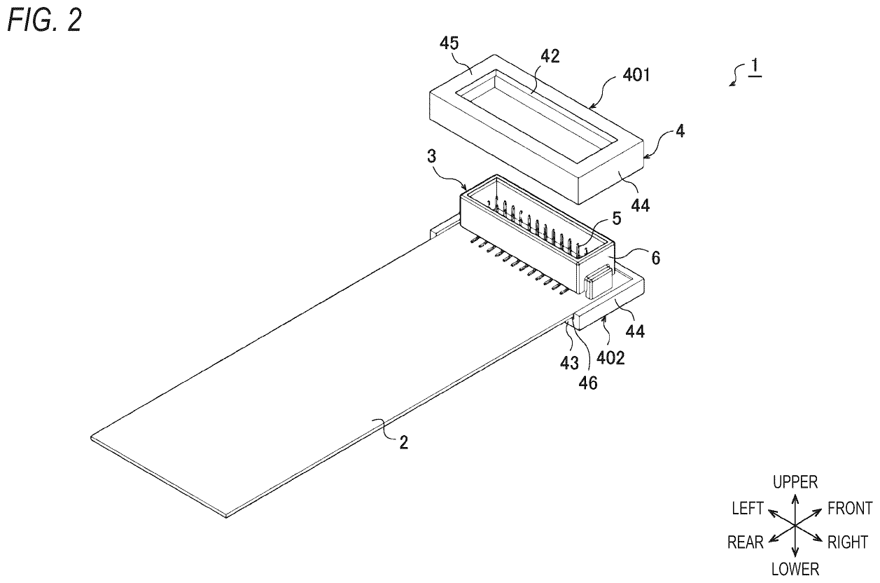

As illustrated in FIG. 2, the connector 3 includes a plurality of terminals 5 electrically connected to the FPC 2 and a connector housing 6 accommodating the plurality of terminals 5. The terminals 5 are made of a conductive material and each have an L shape. In the present embodiment, the terminals 5 are arranged in two front and rear rows in the left-right direction. In the present embodiment, 12 terminals 5 are arranged in the left-right direction in each of the front row and the rear row.

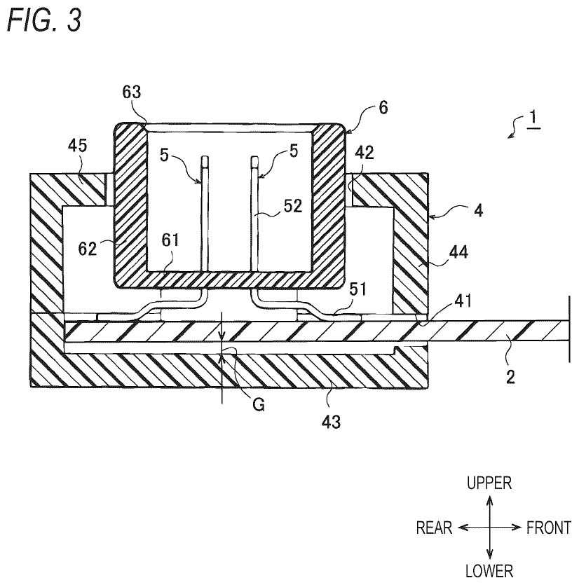

As illustrated in FIG. 3, the terminal 5 includes an FPC connection portion 51 provided on one end side and connected to the FPC 2, and a terminal connection portion 52 provided on the other end side and available to be connected to a mating terminal of a mating connector. The terminal connection portion 52 is provided along the upper-lower direction. The FPC connection portion 51 of the terminal 5 arranged in the front row extends forward from a lower end of the terminal connection portion 52 and is provided along the front-rear direction. The FPC connection portion 51 of the terminal 5 arranged in the rear row extends rearward from the lower end of the terminal connection portion 52 and is provided in the front-rear direction. A distal end of the FPC connection portion 51 according to the present embodiment is disposed on an upper face of the FPC 2 and connected by soldering.

The connector housing 6 is made of resin and is disposed above the FPC 2 in the upper-lower direction. The connector housing 6 has a bottom 61 and a peripheral wall 62 erected upward from a peripheral edge of the bottom 61, and is provided with an opening 63 that is a first opening on an upper side (a side away from the FPC 2) in the upper-lower direction. The connector housing 6 is disposed such that the bottom 61 faces the upper face of the FPC 2 in the upper-lower direction. In terms of the terminal 5, the terminal connection portion 52 passes through the bottom 61 and is accommodated in the connector housing 6, and the FPC connection portion 51 is disposed outside the connector housing 6.

The cover 4 is made of resin. The cover 4 covers a connection portion between the FPC 2 and the terminal 5 and the connector housing 6. As illustrated in FIGS. 1 and 3, the cover 4 has an opening 41 that is a second opening for drawing out the FPC 2 to the outside of the cover 4 and an opening 42 that is a third opening for exposing the opening 63 of the connector housing 6 to the outside of the cover 4.

As illustrated in FIG. 3, the cover 4 has a bottom 43 that covers a lower side of the FPC 2 in the upper-lower direction, a peripheral wall 44 that is erected upward from a peripheral edge of the bottom 43, and a top 45 that is continuous with an upper end of the peripheral wall 44 and faces the bottom 43 in the upper-lower direction. The bottom 43 and the FPC 2 define a gap G in between. A size of the gap G will be described in a second embodiment. The peripheral wall 44 is provided with the opening 41. The top 45 is provided with the opening 42. In the present embodiment, as illustrated in FIG. 1, an upper end of the connector housing 6 protrudes from the opening 42 of the top 45. The FPC connection portion 51 of the terminal 5 in the rear row has a distal end protruding rearward relative to the peripheral wall 62. The FPC connection portion 51 of the terminal 5 in the front row has a distal end protruding forward relative to the peripheral wall 62.

In the present embodiment, as illustrated in FIG. 2, the cover 4 includes an upper cover 401 and a lower cover 402 that are two divided covers in the upper-lower direction obtained by dividing an edge of the opening 41 into two. The lower cover 402 is provided with the bottom 43 and a lower side of the peripheral wall 44. The lower cover 402 is provided with a notch 46 in an upper end of the rear peripheral wall 44. The upper cover 401 is provided with an upper side of the peripheral wall 44 and the top 45. When the upper cover 401 and the lower cover 402 are vertically overlapped, an upper opening of the notch 46 provided in the lower cover 402 is closed by the upper cover 401 and to form the opening 41.

Next, an assembly process of the FPC connector 1 will be described. First, the connector 3 is mounted on an upper face of an end of the FPC 2. At this time, the FPC connection portion 51 is disposed on the upper face of the FPC 2. Next, the FPC connection portion 51 is soldered to electrically connect the connector 3 and the FPC 2. Next, the FPC 2 and the connector 3 are mounted on the lower cover 402 and then the upper cover 401 is attached from above. Accordingly, the FPC 2 is drawn out of the cover 4 through the opening 41.

According to the above-described embodiment, the cover 4 covers a connection portion between the FPC 2 and the terminal 5 and the connector housing 6, the FPC 2 is drawn out from the opening 41, and the opening 63 of the connector housing 6 is exposed from the opening 42. The cover 4 has the bottom 43, the peripheral wall 44, and the top 45. Accordingly, the cover 4 can cover (accommodate) the entire FPC connection portion 51 of the surface mount type connector 3. Therefore, it is possible to prevent a tester or a probe in addition to a finger from touching the FPC connection portion 51 of the terminal 5 (hand touch prevention). It is further possible to prevent water from entering the cover 4 from the outside (improve water-resistant performance).

According to the above-described embodiment, the cover 4 is divided into two in the upper-lower direction by dividing the edge of the opening 41 into two. Accordingly, the FPC 2 can be easily drawn out from the opening 41.

### Second Embodiment

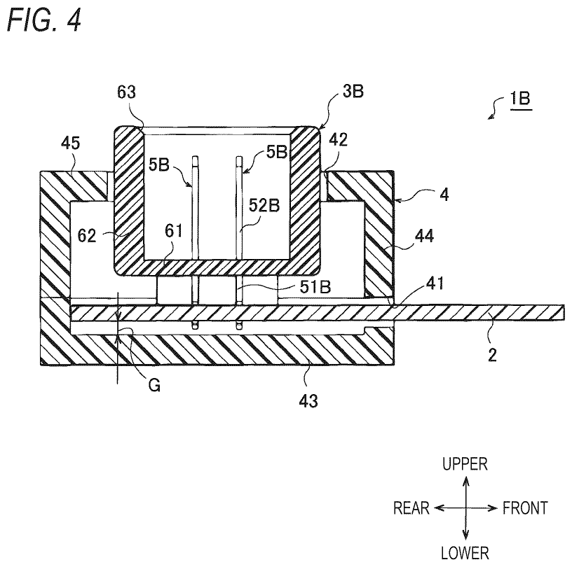

Next, a FPC connector 1B according to the second embodiment will be described with reference to FIG. 4. In FIG. 4, parts equivalent to those of the FPC connector 1 illustrated in FIGS. 1 to 3 described in the first embodiment are given the same reference signs, and detailed description thereof will be omitted. As illustrated in FIG. 4, the FPC connector 1B includes the FPC 2, a through hole type connector 3B connected to the FPC 2, and the cover 4. Since the FPC 2 and the cover 4 are the same as those in the first embodiment, detailed description thereof will be omitted here.

The connector 3B includes a plurality of terminals 5B electrically connected to the FPC 2 and the connector housing 6 accommodating the plurality of terminals 5B. In the present embodiment, the terminals 5B are formed in a straight line along the upper-lower direction.

The terminal 5B includes a FPC connection portion 51B provided on one end side and connected to the FPC 2, and a terminal connection portion 52B provided on the other end side and available to be connected to a mating terminal of a mating connector. In the terminal 5B, the terminal connection portion 52B passes through the bottom 61 and is accommodated in the connector housing 6, and the FPC connection portion 51B is disposed outside the connector housing 6.

The FPC connection portion 51B is inserted into a through hole (not illustrated) penetrating the FPC 2 in the upper-lower direction. The FPC connection portion 51B has a distal end protruding from a lower side of the FPC 2 through the through hole. The gap G is longer than a protruding length of the distal end of the FPC connection portion 51B from the lower side of the FPC 2. Since the connector housing 6 is the same as that of the first embodiment, detailed description thereof will be omitted here.

Next, an assembly process of the FPC connector 1B will be described. First, the connector 3B is mounted on the upper face of the end of the FPC 2. At this time, the FPC connection portion 51B passes through the through hole of the FPC 2, and electrically connects the connector 3B and the FPC 2 without soldering. Attachment of the cover 4 is the same as that of the first embodiment, and thus detailed description thereof is omitted here.

According to the above-described embodiment, the cover 4 can cover (accommodate) the entire FPC connection portion 51B of the through hole type connector 3B. Therefore, it is possible to prevent a tester or a probe in addition to a finger from touching the FPC connection portion 51B of the terminal 5B (hand touch prevention). It is further possible to prevent water from entering the cover 4 from the outside (improve water-resistant performance).

The covers 4 according to the first embodiment and the second embodiment are the same. According to the covers 4, the FPC connection portions 51 and 51B can be covered regardless of whether the connector is the surface mount type connector 3 or the through hole type connector 3B. That is, the common cover 4 can be used for the surface mount type connector 3 and the through hole type connector 3B, and the number of components can be reduced.

### Third Embodiment

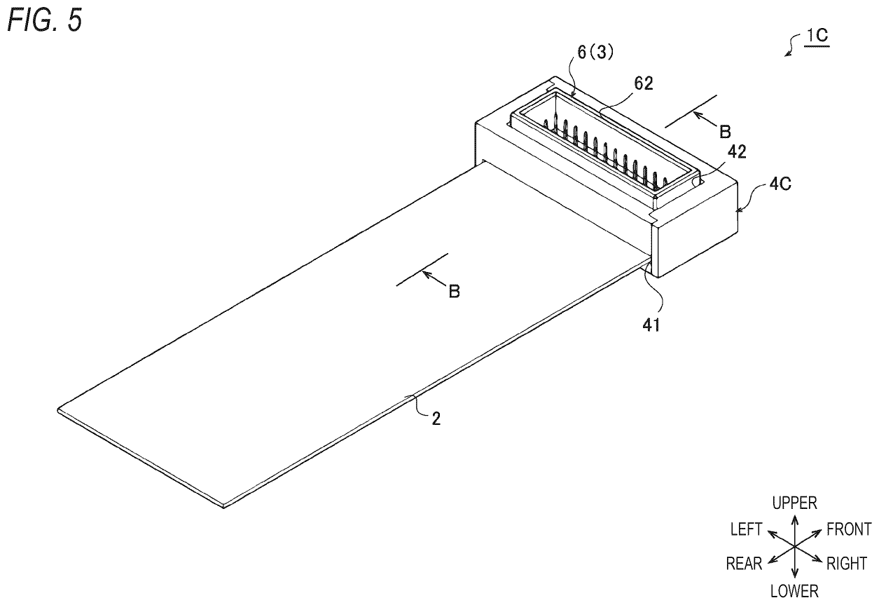

Next, a FPC connector 1C according to a third embodiment will be described with reference to FIGS. 5 to 7. In FIGS. 5 to 7, parts equivalent to those of the FPC connector 1 illustrated in FIGS. 1 to 3 described in the first embodiment are given the same reference signs, and detailed description thereof will be omitted. As illustrated in FIG. 5, the FPC connector 1C includes the FPC 2, the surface mount type connector 3 connected to the FPC 2, and a cover 4C. Since the FPC 2 and the connector 3 are equivalent as those in the first embodiment, detailed description thereof will be omitted here.

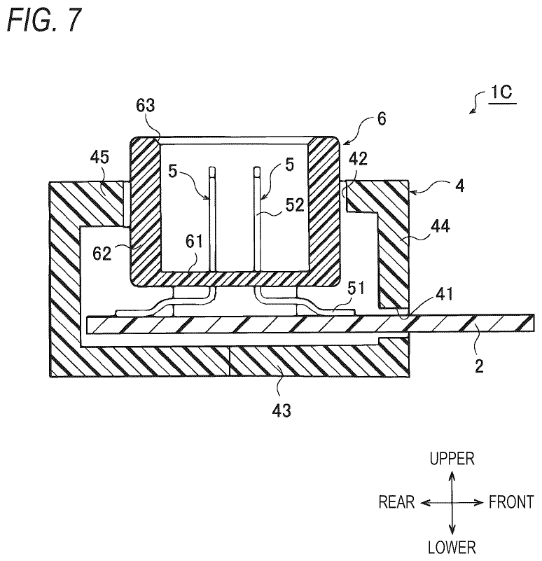

The cover 4C is made of resin. The cover 4C has the opening 41 and the opening 42 as illustrated in FIGS. 5 and 7, which is the same as in the first embodiment. As illustrated in FIG. 5, the cover 4C has the bottom 43, the peripheral wall 44 provided with the opening 41, and the top 45 provided with the opening 42, which is the same as in the first embodiment.

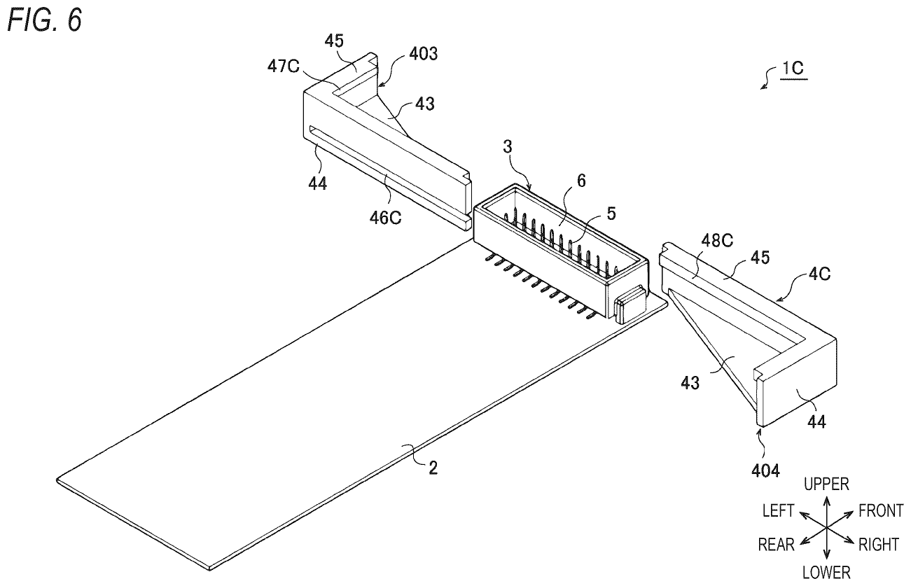

As illustrated in FIG. 6, the cover 4C is different from the cover 4 according to the first embodiment in that the cover 4C has a left cover 403 and a right cover 404 that are two divided covers in the left-right direction obtained by dividing both the edge of the opening 41 and an edge of the opening 42 into two. In the present embodiment, the cover 4C is divided into two by obliquely cutting the rectangular bottom 43 and top 45 along a line intersecting both the left-right direction and the front-rear direction. More specifically, the cover 4C divides the rectangular bottom 43 and top 45 into two by obliquely cutting the bottom 43 and the top 45 along a line connecting a left front corner and a right rear corner.

The left cover 403 is provided with a left rear side of each of the bottom 43 and the top 45, and a left side and a rear side of the peripheral wall 44. The left cover 403 has a notch 46C in a right end of the rear peripheral wall 44. The left cover 403 further has a notch 47C in the top 45. The right cover 404 is provided with a right front side of each of the bottom 43 and the top 45 and a right side and a front side of the peripheral wall 44. The right cover 404 further has a notch 48C in the top 45. When the left cover 403 and the right cover 404 overlap in the left-right direction, a right opening of the notch 46C provided in the left cover 403 is closed by the right cover 404 to form the opening 41. The notch 47C provided in the left cover 403 and the notch 48C provided in the right cover 404 are aligned to form the opening 42.

Next, an assembly process of the FPC connector 1C will be described. First, the connector 3 and the FPC 2 are electrically connected in the same procedure as in the first embodiment. Next, the FPC 2 is inserted from the right opening of the notch 46C provided in the left cover 403, the FPC 2 and the connector 3 are mounted on the bottom 43 of the left cover 403, and then the right cover 404 is overlapped from the right side. Accordingly, the FPC 2 is drawn out of the cover 4C through the opening 41.

According to the above-described embodiment, the cover 4C is divided into two in the left-right direction by dividing the edge of the opening 41 into two. Accordingly, the FPC 2 can be easily drawn out from the opening 41.

### Fourth Embodiment

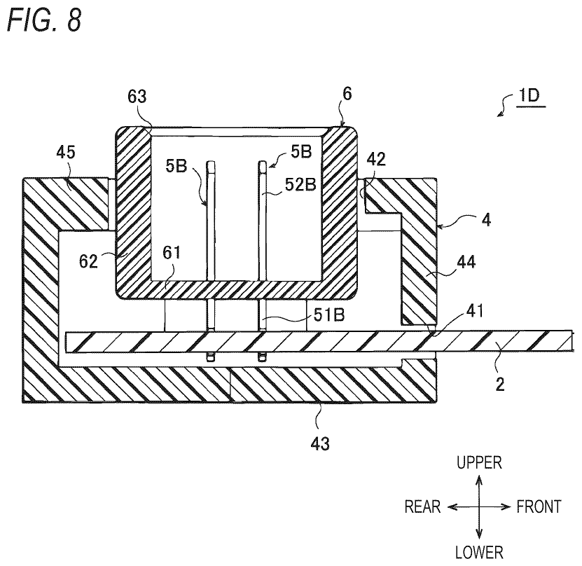

Next, a FPC connector 1D according to a fourth embodiment will be described with reference to FIG. 8. In FIG. 8, parts equivalent to those of the FPC connector 1B illustrated in FIG. 4 described in the second embodiment and the FPC connector 1C illustrated in FIGS. 5 to 7 described in the third embodiment are given the same reference numerals, and detailed description thereof will be omitted. As illustrated in FIG. 8, the FPC connector 1D includes the FPC 2, the through hole type connector 3B connected to the FPC 2, and the cover 4C. Since the FPC 2 and the connector 3B are the same as those in the second embodiment, detailed description thereof will be omitted here.

Since the cover 4C is the same as that in the third embodiment, detailed description thereof is omitted here. That is, in the fourth embodiment, the through hole type connector 3B described in the second embodiment is covered with the cover 4C described in the third embodiment.

Next, an assembly process of the FPC connector 1D will be described. First, the connector 3B and the FPC 2 are electrically connected in the same procedure as in the second embodiment. Next, the cover 4C is attached in the same procedure as in the third embodiment.

The covers 4C according to the third embodiment and the fourth embodiment are the same. According to the covers 4C, the FPC connection portions 51 and 51B can be covered regardless of whether the connector is the surface mount type connector 3 or the through hole type connector 3B. That is, the common cover 4C can be used for the surface mount type connector 3 and the looper type connector 3B, and the number of components can be reduced.

The present disclosure is not limited to the embodiments described above and can be appropriately modified, improved and the like. In addition, materials, shapes, sizes, numbers, arrangement positions and the like of components in the embodiments described above are freely selected and are not limited as long as the present disclosure can be implemented.

According to the third and fourth embodiments, the cover 4C is obliquely cut along a straight line intersecting the left-right direction and the front-rear direction and is divided into two left and right parts, and the present disclosure is not limited thereto. The cover 4 may be divided into two left and right parts by being cut obliquely along a straight line along the front-rear direction.

According to the above-described embodiments, a FPC has been described as an example of a flat circuit body, and the present disclosure is not limited thereto. The flat circuit body may be a printed circuit board or a flexible flat cable (FFC).

Here, features of the embodiments of the connector with a flat circuit body according to the present disclosure are briefly summarized and listed in following [1] to [5].

[1] A connector (1, 1B to 1D) with a flat circuit body, the connector including:
a flat circuit body (2);
a terminal (5, 5B) having one end connected to the flat circuit body (2);
a connector housing (6) disposed above the flat circuit body in a thickness direction (upper-lower direction) of the flat circuit body (2) and provided with a first opening (63) on a side away from the flat circuit body (2) in the thickness direction (upper-lower direction), the connector housing accommodating the other end of the terminal (5, 5B); and
a cover (4, 4C) covering a connection portion between the flat circuit body (2) and the terminal (5, 5B) and the connector housing (6), wherein
the cover (4, 4C) has
   a second opening (41) for drawing out the flat circuit body (2) to an outside of the cover (4, 4C), and
   a third opening (42) for exposing the first opening (63) of the connector housing to the outside of the cover (4, 4C).

According to the connector (1, 1B to 1D) with a flat circuit body having a configuration of [1], it is possible to cover the terminal (5, 5B) regardless of whether the connector is a surface mount type connector (3) or a through hole type connector (3B), and to achieve hand touch prevention and improvement in water-resistant performance.

[2] The connector (1, 1B to 1D) with a flat circuit body according to [1], wherein
the cover (4, 4C) has
   a bottom (43) covering a side of the flat circuit body (2) that is opposite to the connector housing (6) in the thickness direction (upper-lower direction),
   a peripheral wall (44) erected from a peripheral edge of the bottom (43), and
   a top (45) continuous with the peripheral wall (44) and facing the bottom (43) in the thickness direction (upper-lower direction),
the peripheral wall (44) is provided with the second opening (41), and
the top is provided with the third opening (42).

According to the connector (1, 1B to 1D) with a flat circuit body having a configuration of [2], the connection portion between the flat circuit body (2) and the terminal (5, 5B) and the connector housing (6) can be covered by the bottom (43), the peripheral wall (44), and the top (45) of the cover (4, 4C). Accordingly, it is possible to further achieve hand touch prevention and improvement in water-resistant performance.

[3] The connector (1, 1B to 1D) with a flat circuit body according to [2], wherein
the flat circuit body (2) and the bottom (43) of the cover (4, 4C) define a gap (G) in between.

According to the connector (1, 1B to 1D) with a flat circuit body having a configuration of [3], the gap (G) is provided, so that a distal end of the terminal (5B) of the through hole type connector (3B) would not interfere with the cover (4, 4C).

[4] The connector (1, 1B) with a flat circuit body according to [1], wherein
the cover (4) is divided into two in the thickness direction (upper-lower direction) by dividing an edge of the second opening (41) into two.

According to the connector (1, 1B) with a flat circuit body having a configuration of [4], the flat circuit body (2) can be easily inserted into the second opening (41) by being sandwiched between the two divided covers (4).

[5] The connector (1C, 1D) with a flat circuit body according to [1], wherein
the cover (4C) is divided into two in a width direction of the flat circuit body (2) by dividing an edge of the second opening (41) into two.

According to the connector (1C, 1D) with a flat circuit body having a configuration of [5], the flat circuit body (2) can be easily inserted into the second opening (41) by being sandwiched between the two divided covers (4C).

What is claimed is:

1. A connector with a flat circuit body, the connector comprising:
a flat circuit body;
a terminal having one end connected to the flat circuit body;
a connector housing disposed above the flat circuit body in a thickness direction of the flat circuit body and provided with a first opening on a side away from the flat circuit body in the thickness direction, the connector housing accommodating another end of the terminal; and
a cover covering a connection portion between the flat circuit body and the terminal and the connector housing, wherein
the cover has
a second opening for drawing out the flat circuit body to an outside of the cover, and
a third opening for exposing the first opening of the connector housing to the outside of the cover.

2. The connector with a flat circuit body according to claim 1, wherein
the cover has
a bottom covering a side of the flat circuit body that is opposite to the connector housing in the thickness direction,
a peripheral wall erected from a peripheral edge of the bottom, and
a top continuous with the peripheral wall and facing the bottom in the thickness direction,
the peripheral wall is provided with the second opening, and
the top is provided with the third opening.

3. The connector with a flat circuit body according to claim 2, wherein
a gap is provided between the flat circuit body and the bottom of the cover.

4. The connector with a flat circuit body according to claim 1, wherein
the cover is divided into two in the thickness direction so as to divide an edge of the second opening into two.

5. The connector with a flat circuit body according to claim 1, wherein
the cover is divided into two in a width direction of the flat circuit body so as to divide an edge of the second opening into two.
